(19) United States
(12) Patent Application Publication
(10) Pub. No.: US 2025/0170643 A1
(43) Pub. Date: May 29, 2025

(54) FLASH SINTERING WITH ELECTRICAL AND MAGNETIC FIELDS

(71) Applicant: The Regents of the University of Colorado, a body corporate, Denver, CO (US)

(72) Inventors: Syed Idrees Jalali, Denver, CO (US); Rishi Raj, Denver, CO (US)

(21) Appl. No.: 18/837,496

(22) PCT Filed: Feb. 7, 2023
(86) PCT No.: PCT/US23/12541

§ 371 Date: Aug. 9, 2024

Related U.S. Application Data
(60) Provisional application No. 63/308,397, filed on Feb. 9, 2022.

(51) Int. Cl. B22F 3/105

(52) U.S. Cl. CPC B22F 3/105; B22F 2003/1053

(57) ABSTRACT

Methods and systems for forming an object comprising sintered material are disclosed. An exemplary method includes producing a flash process using one or more flash source materials and forming a magnetic field, wherein the magnetic field and the flash process are used to form the object.

### CROSS-REFERENCE TO RELATED APPLICATIONS

This application claims the benefit of U.S. Provisional Application No. 63/308,397, filed Feb. 9, 2022, and entitled “FLASH SINTERING WITH ELECTRICAL AND MAGNETIC FIELDS,” the contents of which are hereby incorporated herein by reference to the extent such content does not conflict with the present disclosure.

### STATEMENT REGARDING FEDERALLY-SPONSORED RESEARCH OR DEVELOPMENT

This invention was made with government support under grant number N00014-18-1-2270, awarded by the Office of Naval Research. The government has certain rights in the invention.

### FIELD

The present invention generally relates to methods and systems for sintering materials.

### BACKGROUND

Sintering is a process of fusing particles together. Sintering often occurs at relatively high temperatures. In some cases, field-assisted sintering processes can be used to sinter materials at lower temperatures than are otherwise required to sinter the materials.

Generally, there are considered to be three types of field-assisted sintering processes: (i) microwave sintering, (ii) spark-plasma sintering or SPS, where powders are sintered under high pressure in a hot press-like configuration, except that a graphite die is heated directly with high current, and (iii) flash sintering, where a field is applied to an otherwise bare specimen using a pair of electrodes that contact the specimen.

Typical flash sintering includes suspending a specimen in a furnace, using conductive paste and wires to ensure desired conductivity between a power source and the specimen, heating the specimen (e.g., at a constant temperature ramp rate), and applying a direct current (DC) field to the specimen using the power source and the wires. Flash sintering typically occurs in just a few seconds, e.g., at a threshold value of the furnace temperature. A higher value of the DC field generally lowers the flash temperature. The onset of the flash is generally accompanied by a nonlinear increase in a conductivity of the specimen, such as when a current in the specimen rises. Power supplied to the specimen during the sintering process can then be switched to current control for a period of time to complete the sintering process. An exemplary flash sintering process is described in U.S. Publication No. 2013/0085055A1 and entitled Methods of Flash Sintering, and is described in Influence of the Field and the Current Limit on Flash Sintering at Isothermal Furnace Temperatures, J. Am. CERAM. Soc., 96 [9]2754-2758 (2013), the contents of which are hereby incorporated herein by reference, to the extent such contents do not conflict with the present disclosure.

While flash sintering can be used to sinter materials at reduced temperatures, it may be difficult to sinter materials with irregular shapes. Further, it may be desirable to flash sinter material without directly contacting the material with a conductive wire. Accordingly, improved methods for sintering material are desired.

Any discussion, including discussion of problems and solutions, set forth in this section has been included in this disclosure solely for the purpose of providing a context for the present disclosure. Such discussion should not be taken as an admission that any or all of the information was known at the time the invention was made or otherwise constitutes prior art.

### SUMMARY

This summary may introduce a selection of concepts in a simplified form, which may be described in further detail below. This summary is not intended to necessarily identify key features or essential features of the claimed subject matter, nor is it intended to be used to limit the scope of the claimed subject matter.

Various embodiments of the disclosure relate to methods and systems for forming an object using flash sintering and a magnetic field. As set forth in more detail below, exemplary methods and systems allow for touch-free sintering of materials, such as ceramics. Further, exemplary methods can be used to sinter three-dimensional material (e.g., a preform), which can have an irregular or complex shape.

In accordance with examples of the disclosure, a method of forming an object comprising sintered material includes the steps of: stationing a preform within a reaction chamber, producing a flash process using a flash source material, and forming a magnetic field, wherein the magnetic field and the flash process are used (e.g., in tandem) to form (e.g., sinter) the object. In some cases, the method does not include directly applying current to the preform using a conductor, such as a wire. The step of producing a flash process can include application of an electrical field and current to one or more flash source materials. The preform can be in the form of an irregular three-dimensional object. The flash process can produce electroluminescence. The magnetic field can be formed using one or more magnetic induction coils. A duration of the flash process can be less than 100 seconds or between about 1 second and about 500 seconds. In accordance with examples of the disclosure, the one or more flash source materials are held in a steady state of flash under current control. In accordance with further examples of the disclosure, the step of producing a flash process comprises providing current-controlled power to the one or more flash source materials. The one or more flash source materials can be or include a ceramic. In some cases, the one or more flash source materials comprise an oxide. In some cases, the one or more flash source materials comprise a metal.

In accordance with additional examples of the disclosure, a system for sintering material is provided. An exemplary system includes a reaction chamber, a first power supply to supply power to flash source material to produce a flash process, and a second power supply to form a magnetic field within the reaction chamber. As noted above, the flash process and the magnetic field, e.g., formed with an induction coil, can be used to sinter material. The first power supply can be operated in one or more modes, including a controlled current mode. At least one power supply can be configured to supply current to a flash source material until a (e.g., non-linear) drop in voltage or other indication of flash sintering is detected and then switch to current control for a period of time—e.g., until the sintering process is completed. The system can further include an induction coil, wherein the induction coil at least partially surrounds the flash source material and/or the preform or object. The induction coil can be electrically coupled to the second power supply. Exemplary systems can further include a heater. The heater can be combined with (e.g., form part of or be integral with or attached to) the induction coil.

In accordance with additional examples of the disclosure, an object formed using a method and/or system as described herein is provided.

These and other embodiments will become readily apparent to those skilled in the art from the following detailed description of certain embodiments having reference to the attached figures. The invention is not limited to any particular embodiments disclosed.

### BRIEF DESCRIPTION OF THE DRAWING FIGURES

A more complete understanding of the embodiments of the present disclosure may be derived by referring to the detailed description and claims when considered in connection with the following illustrative figures.

FIG. 1 illustrates a system in accordance with examples of the disclosure.

FIG. 2 illustrates flash source material and a preform in accordance with examples of the disclosure.

FIG. 3 illustrates a magnetic field formed in accordance with examples of the disclosure.

FIG. 4 illustrates flash source material and a preform in accordance with examples of the disclosure.

FIG. 5 illustrates voltage versus time and current versus time of a flash sintering process in accordance with examples of the disclosure.

FIG. 6 illustrates temperature versus time of a flash sintering process in accordance with examples of the disclosure.

FIGS. 7 and 8 illustrate electroluminescence during flash sintering in accordance with examples of the disclosure.

FIG. 9 illustrates the wavelength spectrum of 8YSZ material from 100 nm to 1000 nm, comparing electroluminescence of conventional sintering and touch free sintering in accordance with examples of the disclosure.

FIG. 10 illustrates microstructure development of material in accordance with examples of the disclosure.

FIG. 11 illustrates sample shrinkage as a result of flash sintering in accordance with examples of the disclosure.

FIG. 12 illustrates density versus current (I_{ind}) sintering in accordance with examples of the disclosure.

FIG. 13 illustrates voltage versus time for various flash sintering configurations in accordance with examples of the disclosure.

FIG. 14 illustrates before and after images of objects formed using flash sintering in accordance with examples of the disclosure.

FIG. 15 illustrates a preform and an object in accordance with yet additional examples of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION

The description of exemplary embodiments of methods and systems provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features. For example, various embodiments are set forth as exemplary embodiments and may be recited in the dependent claims. Unless otherwise noted, the exemplary embodiments or components thereof may be combined or may be applied separate from each other.

In this disclosure, any two numbers of a variable can constitute a workable range of the variable, and any ranges indicated may include or exclude the endpoints. Additionally, any values of variables indicated (regardless of whether they are indicated with “about” or not) may refer to precise values or approximate values and include equivalents, and may refer to average, median, representative, majority, or the like. Further, in this disclosure, the terms including, constituted by and having refer independently to typically or broadly comprising, comprising, consisting essentially of, or consisting of in some embodiments.

In this disclosure, any defined meanings do not necessarily exclude ordinary and customary meanings, in some embodiments.

Examples of the disclosure provide methods and systems for sintering material. As described in more detail below, exemplary methods use a plasma or plasma corona produced from a flash source material during a flash sintering process and a magnetic field to, in turn, sinter another material (a preform or workpiece). A synergistic effect arises from the combination of the magnetic field and the sintering of the flash source material, which allows for touch-free sintering of the preform. Such techniques can be used to sinter preforms of irregular, three-dimensional shapes, in a relatively short amount of time and/or at relatively low temperatures.

In accordance with examples of the disclosure, a method of forming an object comprising sintered material includes stationing a preform within a reaction chamber, producing a flash process using one or more flash source materials (sometimes referred to simply as flash source material), and forming a magnetic field. The magnetic field and the flash process are used to sinter the preform to thereby form the object. The flash process can form a plasma or plasma corona that is coupled to the preform or workpiece by the magnetic field. This allows sintering of three-dimensional and/or complex shapes without directly applying current to the preform using a conductor—e.g., without directly contacting the workpiece with wires. Further, such techniques can be used to sinter relatively large objects using relatively low energy/heat. This reduced energy requirement can have a large impact on climate change.

The step of stationing a preform within a reaction chamber can include providing any suitable workpiece within the reaction chamber. By way of examples, the preform can be or include green ceramic and metallic materials, such as compounds that include and may be combinations of zirconia, yttria, alumina titania, iron oxide, bismuth oxide, and those commonly known as high entropy oxides and metals and the like. The preform can be used to form various objects, such as dental restoration objects or the like.

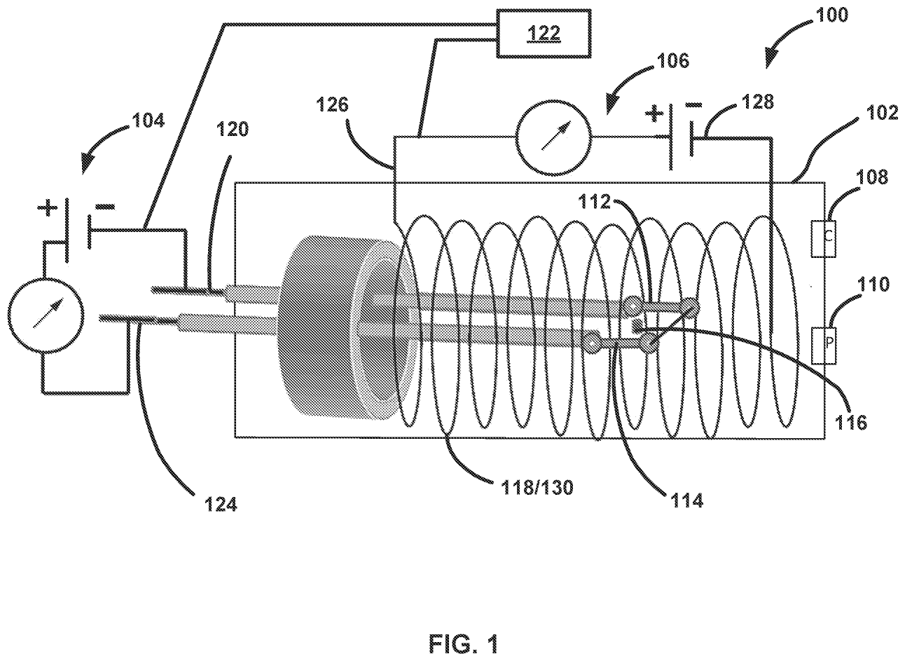

The preform can be in the form of an irregular three-dimensional shape. A relative green density of the preform can be greater than 30%, or between about 45% and about 65%. An exemplary reaction chamber can be an isothermal reactor. A particular exemplary system/reactor is described in more detail below in connection with FIG. 1.

The step of producing a flash process can include providing heat and current to the flash source material. The applied current can form an electrical field. An exemplary flash process includes electrically coupling (e.g., with conductive wires and paste) the flash source material to a power supply. The flash source material can then be heated (e.g., at a relatively constant rate—e.g., within +/−5, 2, or one percent), while applying a DC current to the sample. Flash sintering typically occurs within a few seconds when a threshold temperature in combination with a current from the power supply reaches threshold limits. Generally, a higher current results in a lower flash temperature.

An onset of the flash can be accompanied by a nonlinear increase in a conductivity of the workpiece, such that the current in the specimen rises/the voltage drops. In accordance with examples of the disclosure, a current limit of the power supply can be set to (e.g., automatically) switch the operation of the power supply to current control operation—e.g., within less than one second of the detection of an onset of the flash. Thus, in accordance with examples of the disclosure, the step of producing a flash process comprises providing current-controlled power to the one or more flash source materials. The one or more flash source materials can be held in a steady state (e.g., constant temperature and applied current—e.g., within +/−5, 2, or 1 percent for each parameter) of flash under current control for a duration. The flash process may be relatively short in duration. For example, the flash process can be less than 100 seconds or between about 1 and about 500 seconds once flash initiates.

The one or more flash source materials can be or include a ceramic, an oxide, a metal, or the like. Such materials can be or include one or more oxides of transition metals, rare-earths and metals in the main groups (e.g., groups 11, IV and V) of the periodic table. By way of particular examples, the flash source material comprises one or more of: yttria stabilized zirconia, yttrium oxide, hafnium oxide, or cerium oxide. A number of flash source materials can depend on a size and/or a three-dimensional configuration of the preform. In some cases, the one or more flash source materials include two or more flash source materials. In some cases, the flash source materials comprise 3, 4, 5, or 10 or more flash source materials. The flash source materials can be the same or different materials.

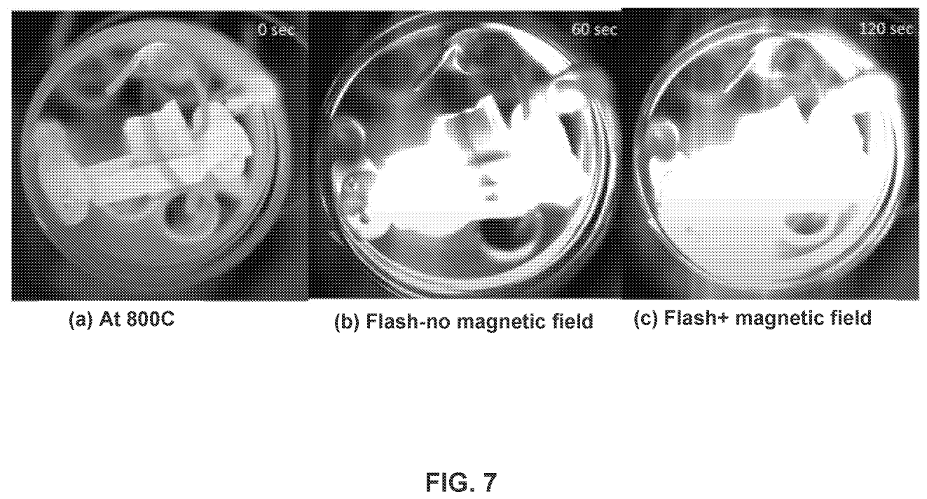

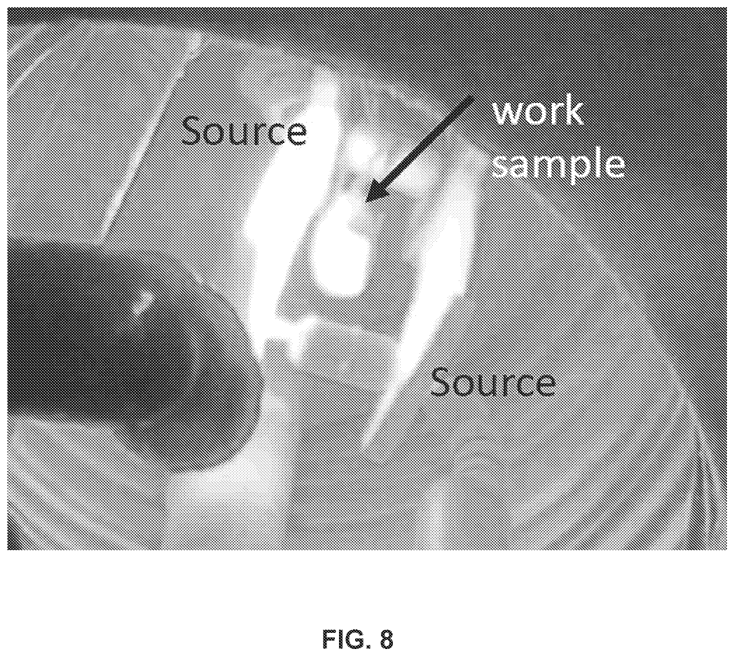

In accordance with further examples of the disclosure, the flash process produces electroluminescence. Such electroluminescence is described in more detail below in connection with FIGS. 7 and 8.

During the step of forming a magnetic field, a magnetic field is produced to couple the plasma formed during the flash sintering to the preform/workpiece. A strength of the magnetic field can be between about 0.001 and about 1 T or between about 0.001 and about 100 T. The magnetic field can be formed, for example, using one or more magnetic induction coils. As described below, the induction coil(s) can be coupled to or include a heater.

Turning now to the drawing figures, FIG. 1 illustrates a system 100 for sintering material in accordance with further examples of the disclosure. System 100 includes a reaction chamber 102, a first power supply 104 to supply power to flash source material to produce a flash process, and a second power supply 106 to form a magnetic field within the reaction chamber. The flash process and the magnetic field are used to sinter material 116 (e.g., a preform).

Reaction chamber 102 can be or include any suitable reaction chamber. By way of example, reaction chamber 102 can be or include an isothermal reaction chamber. Reaction chamber 102 can be formed of any suitable material, such as quartz, alumina, zirconia, etc. Reaction chamber 102 can be configured to ramp up a temperature within the reaction chamber until an onset of flash. For example, reaction chamber 102 can be configured to ramp a temperature of material 116 at a relatively constant ramp rate (e.g., about 10° C./minute).

First power supply 104 can be or include any power supply configured to provide current to one or more flash source materials 112, 114. First power supply 104 can be a direct current power supply. Byway of example, first power supply 104 can be configured to provide a current supplied to one or more flash source materials 112, 114 in a current limit mode until an onset of flash is detected and then (e.g., automatically) switch to a constant current mode to supply a constant current (e.g., about 0.1 to about 10 A or about 10 A to about 100 A)—e.g., until sintering is complete (e.g., in less than 1 minute or in about 1 second to 500 seconds). Thus, the first power supply 104 can include a controlled current power supply. Power from first power supply 104 can be provided to one or more flash source materials 112, 114 via conductors (e.g., wires) 120, 124 and optionally a conductive paste-not separately illustrated.

Second power supply 106 is configured to provide power to, e.g., an induction coil 118, to form a magnetic field. Similar to first power supply 104, second power supply 106 can include a controlled current power supply. Second power supply 106 can be configured to control current from about 0.1 A to 10 A or between about 10 A to 100 A. Power from second power supply 106 can be provided to induction coil 118 via conductors (e.g., wires) 126, 128.

Induction coil 118 can be formed of any suitable conductive material. As illustrated, induction coil 118 at least partially surrounds flash source material 112, 114 and/or material/preform 116.

As illustrated in FIG. 1, system 100 can also include a controller 122 to control the power of first power supply 104 and second power supply 106. In accordance with examples of the disclosure, controller 122 is configured with a feedback loop to the time scale of less than 1 millisecond, such that controller 122 can provide a signal to first and/or second power supply 104, 106 within such timeframe to provide desired power (e.g., current) to flash source material 112, 114 or induction coil 118. For example, controller 122 and/or first power supply 104 can be configured to measure or detect a drop in voltage and/or when the second power supply 106 is switched on. In accordance with examples of the disclosure, the drop in voltage is accompanied by and/or associated with a voltage drop; upon detecting such voltage drop, controller 122 can initiate and control power to power supply 106.

In some cases, system 100 also includes a heater 130. Heater 130 can be integral with or coupled to coil 118.

As further illustrated in FIG. 1, system 100 can include a camera 108 and/or a temperature measurement device, such as a pyrometer 110.

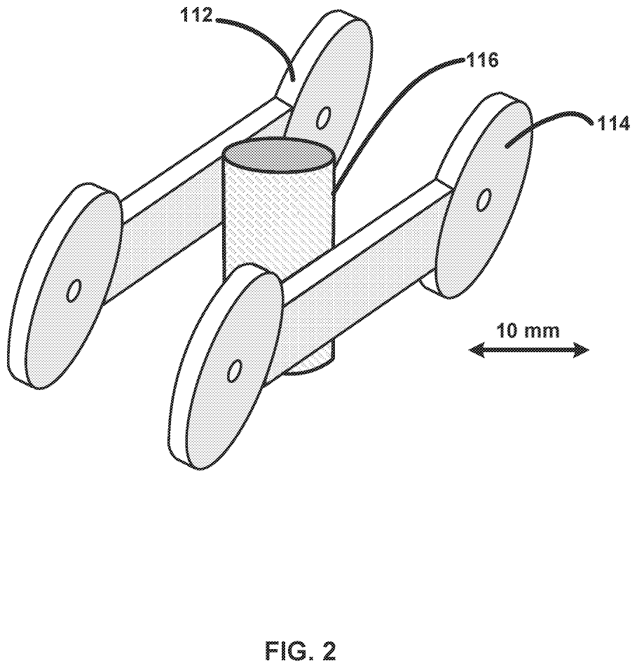

FIG. 2 illustrates an enlarged view of flash source materials 112, 114 and material 116.

As illustrated, flash source materials 112, 114 may suitably be dog-bone shaped. Flash source materials 112, 114 can be as described above. System 100 can include any suitable number of flash source materials 112, 114 to accommodate the irregular shape to promote relatively even sintering of the workpiece.

Material 116 can have a three-dimensional shape, which may be irregular. Material 116 can be or include any of the preform material described above.

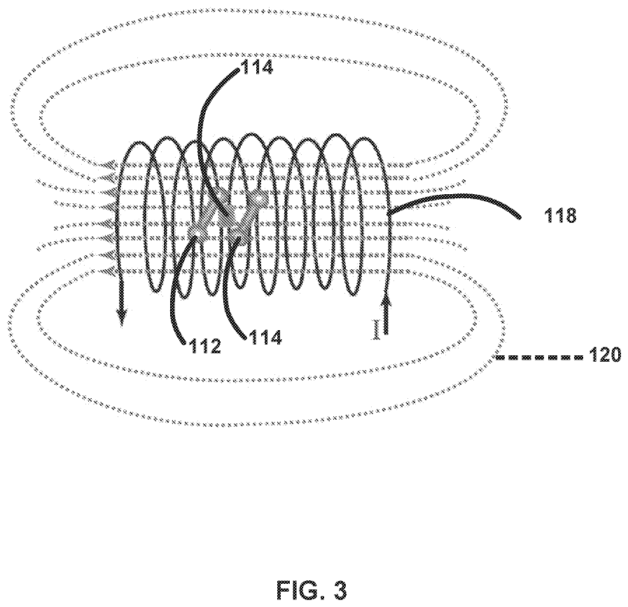

FIG. 3 illustrates a magnetic field 120 that can be formed using induction coil 118 and second power supply 106. As noted above, the magnetic field can be used to couple a plasma that forms from flash sintering the flash source material to material 116.

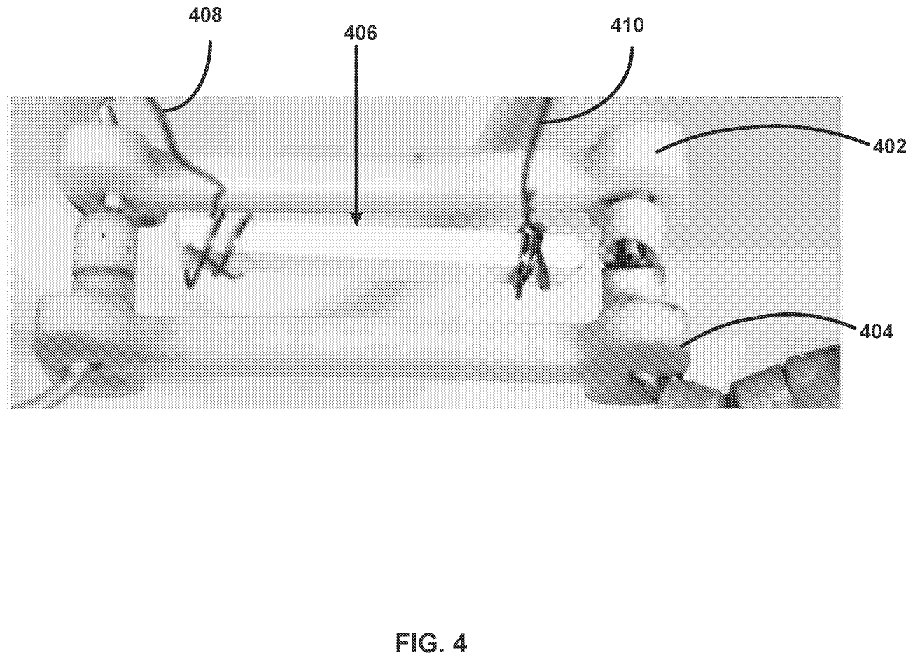

FIG. 4 illustrates additional examples of flash source materials 402, 404 and material 406. Flash source materials 402, 404 and material 406 can be the same or similar to flash source materials 112, 114 and material 116. As illustrated, material 406 can be independently suspendered—e.g., using wires 408, 410. Material 406 can be interposed between opposing flash source materials 112, 114.

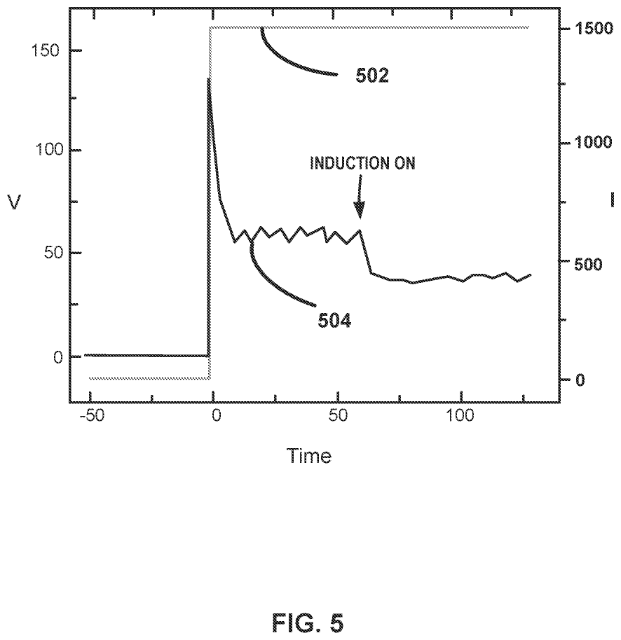

FIG. 5 illustrates voltage (V) and current in units of electric field (V cm⁻¹) and current density mA mm⁻² versus time for a sintering process in accordance with examples of the disclosure. More particularly, FIG. 5 illustrates coupling of magnetic induction with the plasma formed during a flash. Line 502 illustrates the current density which is held constant. Line 504 illustrates the change in the electric field when the magnetic field is switched on.

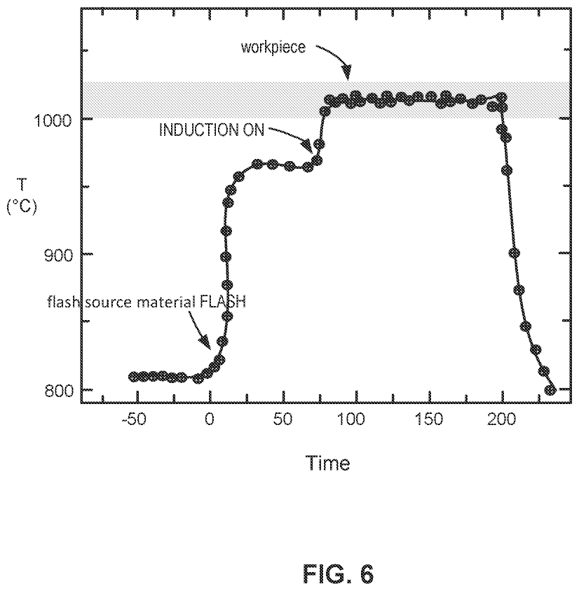

FIG. 6 illustrates temperature versus time during a sintering process in accordance with examples of the disclosure. As illustrated, the temperature can begin to rise rapidly at an onset of flash and again once a magnetic field is generated. The workpiece/material can then be held at a relatively constant temperature for a period of time prior to cooling the workpiece.

FIG. 7 illustrates electroluminescence that occurs during a flash process as described herein. FIG. 7 (a) illustrates a workpiece with no flash; (b) illustrates flash/electroluminescence with no applied magnetic field; and (c) illustrates flash/electroluminescence with an applied magnetic field, illustrating a coupling of the flash plasma and the workpiece.

FIG. 8 illustrates another image of electroluminescence in a touch-free state, showing the glowing of the workpiece.

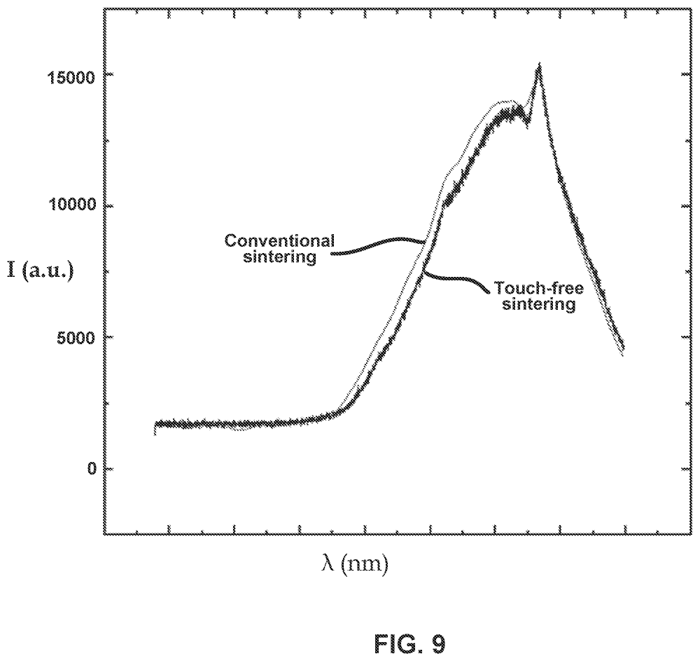

FIG. 9 illustrates the electroluminescence spectrum for material sintered using conventional flash sintering and using touch-free sintering as described herein.

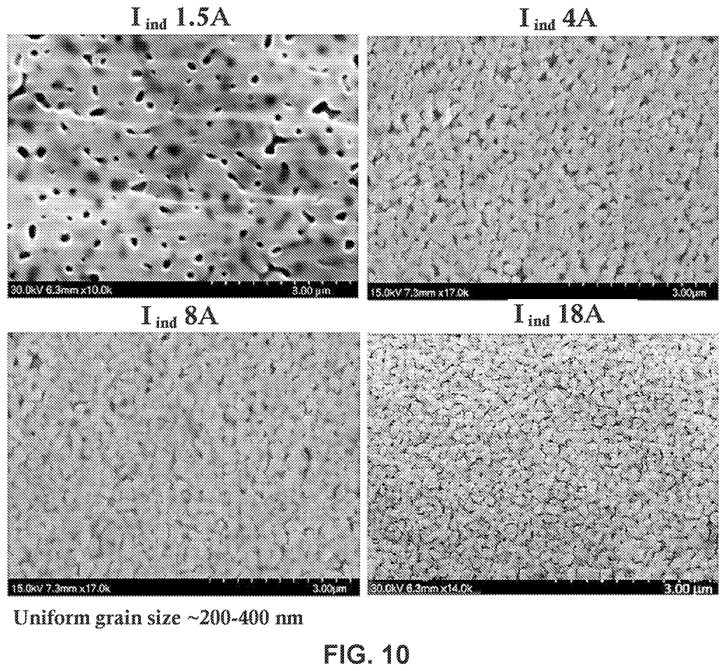

FIG. 10 illustrates microstructure development in material sintered using a system and/or method as described herein. As illustrated, a grain size of about 200 to about 400 nm can be obtained using a system and/or method as described herein.

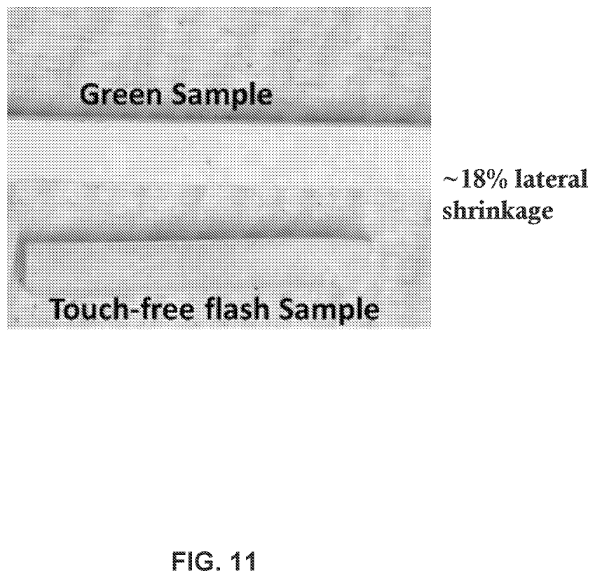

FIG. 11 illustrates a preform or green sample and a sintered or touch-free flash sample.

As illustrated, the material can shrink into a self-similar shape. This is true even for relatively complex three-dimensional shapes. In this particular illustrated example, the shrinkage was about 18 percent in a lateral direction.

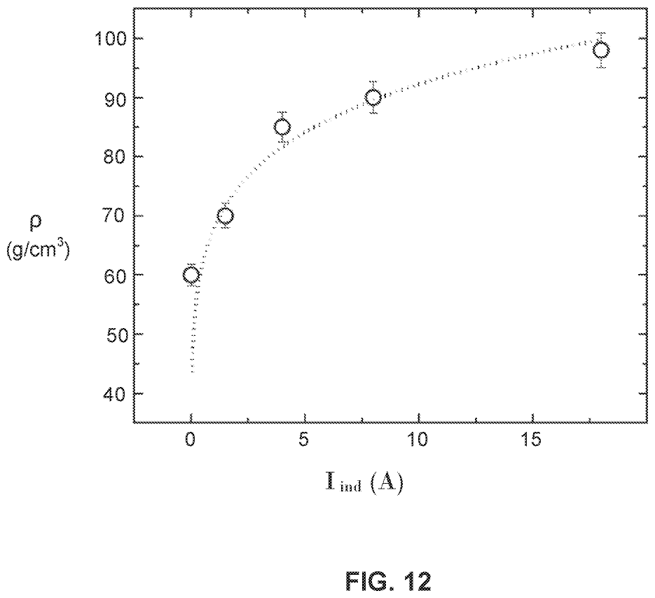

FIG. 12 illustrates density of a workpiece as a function of current flowing through the magnetic coil during the flash process. As illustrated, the density generally increases as the current in the magnetic coil is increased.

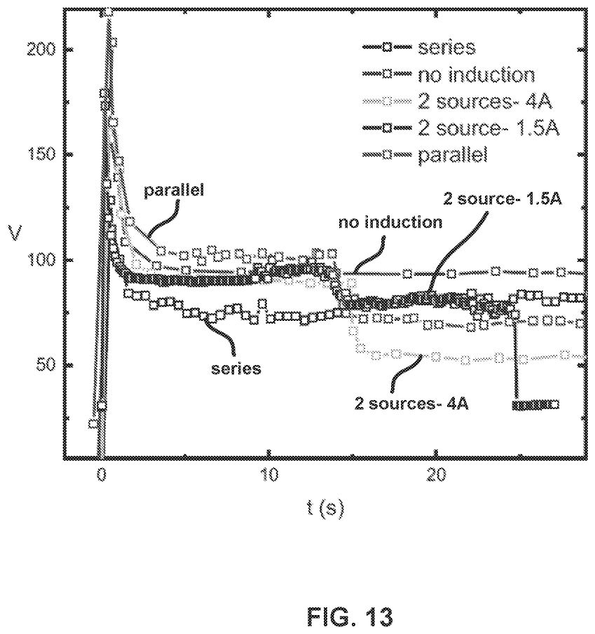

FIG. 13 illustrates voltage versus time curves for various configurations, including series, no induction, two flash source materials at 4 amps, two flash source materials at 1.5 amps, and a parallel configuration. The two flash source configurations are shown in FIG. 2 as flash source material 112 and 114; in the example they were made from yttria stabilized zirconia; but may alternatively be constituted from titanium oxide, other oxides, or other flash source materials described herein. The shape of the flash source in the example are dog bone; but may alternatively be rectangular or rod shapes or the like. Workpiece 116 can be of an arbitrary shape and size.

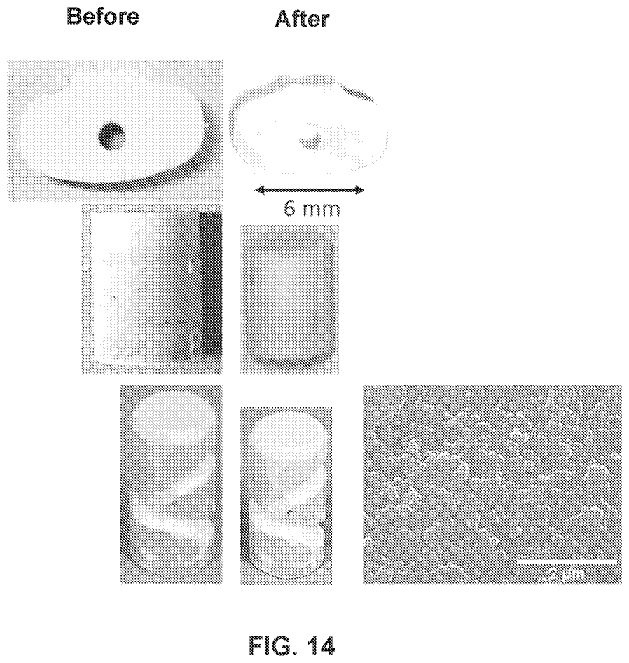

FIG. 14 illustrates before and after images for workpieces that are sintered using a system and/or method as described herein. As illustrated, the method and system can be used to sinter relatively complex three-dimensional shapes.

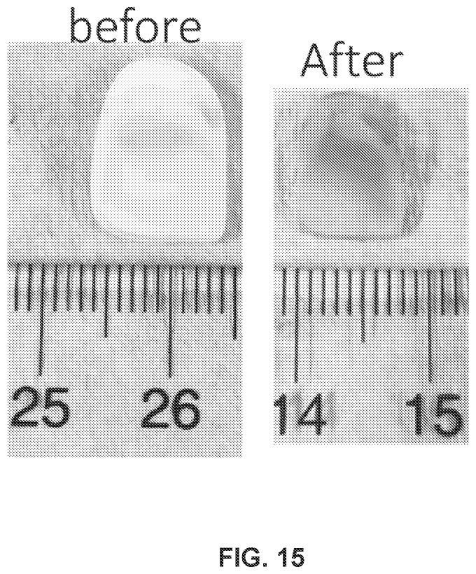

FIG. 15 illustrates a before and after image of a dental implant formed according to a method and/or using a system as described herein.

TABLE 1

| | sample description | Relative density (%) |
|---|---|---|
| green density | | 59.3 |
| Only flash | irregular shape | 80. |
| | dogbone | 86.9 |
| Flash + induction | induction-Series | 93.7 |
| | induction-2source | 95.5 |
| | induction-Parallel | 97.6 |
| | Induction-2source-4A | 99.2 |
| | Induction-2source-18A | 99.6 |

The example embodiments of the disclosure described above do not limit the scope of the invention, since these embodiments are merely examples of the embodiments of the invention, which is defined by the appended claims and their legal equivalents. Any equivalent embodiments are intended to be within the scope of this invention. Various modifications of the disclosure, in addition to those shown and described herein, such as alternative useful combinations of the elements described, may become apparent to those skilled in the art from the description. Such modifications and embodiments are also intended to fall within the scope of the appended claims.

1. A method of forming an object comprising sintered material, the method comprising the steps of:
stationing a preform within a reaction chamber;
producing a flash process using one or more flash source materials; and
forming a magnetic field,
wherein the magnetic field and the flash process are used to form the object.

2. The method of claim 1, wherein the method does not include directly applying current to the preform using a conductor.

3. The method of claim 1, wherein the step of producing a flash process comprises application of heat current to one or more flash source materials.

4. The method of claim 1, wherein the preform has a relative green density of greater than 30%, or between about 45% and about 65%.

5. (canceled)

6. The method of claim 1, wherein a strength of the magnetic field is between about 0.001 and about 1 T or about 0.001 and about 100 T.

7. The method of claim 1, wherein the magnetic field is formed using one or more magnetic induction coils.

8. The method of claim 1, wherein the flash process produces electroluminescence.

9. The method of claim 1, wherein a duration of the flash process is less than 100 seconds or between about 1 and about 500 seconds.

10. The method of claim 3, wherein the step of producing a flash process comprises providing current-controlled power to the one or more flash source materials.

11. The method of claim 3, wherein the one or more flash source materials comprise a ceramic.

12. The method of claim 3, wherein the one or more flash source materials comprise an oxide.

13. The method of claim 3, wherein the one or more flash source materials comprise a metal.

14. The method of claim 3, wherein the one or more flash source materials are held in a steady state of flash under current control.

15. The method of claim 3, wherein the one or more flash source materials comprise one or more of: yttria stabilized zirconia, yttrium oxide, hafnium oxide, and cerium oxide.

16. The method of claim 3, wherein the one or more flash source materials comprise one or more oxides of transition metals, rare-earths and metals in the main groups of the periodic table.

17. A system for sintering material, the system comprising:
a reaction chamber;
a first power supply to supply power to flash source material to produce a flash process; and
a second power supply to form a magnetic field within the reaction chamber,
wherein the flash process and the magnetic field are used to sinter material.

18. The system of claim 17, wherein the first power supply comprises a controlled current power supply.

19. The system of claim 17, wherein the second power supply comprises a controlled current power supply.

20. The system of claim 18, comprising a controller to control a power of the first and second power supplies with a feedback loop to the time scale of less than 1 millisecond.

21. The system of claim 17, wherein the first power supply measures a drop in voltage when the second power supply is switched on.

22-29. (canceled)
